(19) United States
(12) Patent Application Publication
(10) Pub. No.: US 2013/0132996 A1
(43) Pub. Date: May 23, 2013

(54) SYSTEM AND METHOD FOR DISPLAYING PRODUCT INFORMATION ABOUT ADVERTISEMENT ON DIGITAL TELEVISION, AND RECORDING MEDIUM THEREOF

(71) Applicants: Chen-Ming Wu, Chiayi City (TW); Wen-Tai Hsieh, Taipei City (TW); Kung-Ming Sung, Kaohsiung City (TW); Tsun Ku, Taipei City (TW); Bo-Chin Tsai, New Taipei City (TW)

(72) Inventors: Chen-Ming Wu, Chiayi City (TW); Wen-Tai Hsieh, Taipei City (TW); Kung-Ming Sung, Kaohsiung City (TW); Tsun Ku, Taipei City (TW); Bo-Chin Tsai, New Taipei City (TW)

(21) Appl. No.: 13/558,553

(22) Filed: Jul. 26, 2012

(30) Foreign Application Priority Data
Nov. 22, 2011 (TW) 100142756

(51) Int. Cl. H04N 21/458

(52) U.S. Cl. 725/32

(57) ABSTRACT

A system and a method for displaying product information about advertisement on digital television, and a record medium thereof are provided, applicable to a server and a digital media playback device that are connected through a network. The server stores at least one piece of channel advertisement information and at least one piece of product description data corresponding to a plurality of media. The digital media playback device is used for sending an instruction of advertisement information. The instruction of advertisement information includes specific information. While acquiring the instruction of advertisement information, the server compares the specific information with the channel advertisement information to find target product description data from the product description data corresponding to the channel advertisement information and return to the digital media playback device. The digital media playback device plays the playback media and the target product description data.

### CROSS-REFERENCE TO RELATED APPLICATION

This application claims the benefit of Taiwan Patent Application No. 100142756, filed on Nov. 22, 2011, which is hereby incorporated by reference for all purposes as if fully set forth herein.

### BACKGROUND OF THE INVENTION

1. Field of Invention

The present invention relates to a system and a method for displaying product information about advertisement on digital television, and a recording medium thereof, and more particularly to a system and a method capable of instantly acquiring product descriptions of a product in a television advertisement, and a recording medium thereof.

2. Related Art

In the prior art, when consumers are interested in a product in a TV advertisement and intend to obtain more detailed product descriptions, the related information of the product are usually acquired by adopting the following methods.

In the first method, the contact information of a dealer is obtained through the advertisement, and the product descriptions are then acquired through a phone call, a letter, an E-mail, or by visiting a related retail store personally, or the product descriptions are obtained by inquiring the manufacturer or service staff in the retail store.

In the second method, the related product descriptions, for example, detailed functions, distinguishing features, sales locations, prices, and comments from users for product may be acquired by searching various relevant websites or forums on the Internet.

However, the above methods cause some inconveniences as follows. In the first method, many dealers only describe the advantages of their selling products, so the comments are subjective, which affect the accuracy of the understanding on the product for consumers. In the second method, consumers have to use an electronic apparatus other than a television. The electronic apparatus is required to be connected to the Internet and open a webpage so that the consumers can find related information of a product or comments on a product by the other users. In addition, consumers have to search different websites to collect more information to understand a product in various aspects, so as to ensure the accuracy of the understanding on the product, which may take a long time.

### SUMMARY OF THE INVENTION

In view of the above, the present invention provides a system and a method capable of instantly acquiring product descriptions of a product in a television advertisement and displaying the product descriptions, and a recording medium thereof.

The system for displaying product information about advertisement on digital television disclosed in the present invention comprises a digital media playback device and a server.

The digital media playback device comprises a device processing module and a display module. The device processing module acquires one of a plurality of playback media from a media providing apparatus through channel information for playback on the display module, and sends an instruction of advertisement information comprising specific information. The server is connected to the digital media playback device and comprises a serving storage module and a serving processing module. The serving storage module stores at least one piece of channel advertisement information and at least one piece of product description data respectively corresponding to at least one of the plurality of playback media. While acquiring the instruction of advertisement information, the serving processing module compares the specific information and the at least one piece of channel advertisement information to find target product description data from the product description data corresponding to all channel advertisement information and output the target product description data to the digital media playback device. While acquiring the target product description data, the device processing module plays the playback media and the target product description data on the display module.

The method for displaying product information about advertisement on digital television is applicable to a server and a digital media playback device that are connected through a network. The digital media playback device acquires one of a plurality of playback media from a media providing apparatus through channel information for playback. The server stores at least one piece of product description data respectively corresponding to at least one of the plurality of playback media. The method comprises: sending, by a digital media playback device, an instruction of advertisement information to a server, in which the instruction of advertisement information comprises specific information; comparing, by the server, an acquisition time of the instruction of advertisement information and the comprised specific information with prestored at least one piece of channel advertisement information; finding target product description data from at least one piece of product description data corresponding to the channel advertisement information and outputs the target product description data to the digital media playback device; and, acquiring, by the digital media playback device, the target product description data to display the playback media and the target product description data.

The present invention further discloses a non-transitory recording medium, which stores a computer readable program code. A server and a digital media playback device that are connected through a network read the program code to collaborate to implement a method for displaying product information about advertisement on digital television. The digital media playback device acquires one of a plurality of playback media from a media providing apparatus through channel information for playback. The server stores at least one piece of product description data respectively corresponding to at least one of the plurality of playback media. A process of the method is as described above, which is not described in detail here.

The characteristic of the present invention lies in that: people can instantly acquire related descriptions of a product in an advertisement and instantly learn about comprehensive comments on the product from other users, so as to rapidly establish accurate knowledge of the product and further make use of comment information on the product by multiple users in the network. Moreover, consumers no longer need to access the network with an additional electronic apparatus and no longer waste a long time to learn about a product, so that people can have more flexible arrangement of the personal time. Furthermore, the system may be combined with a shopping platform, so the design and planning of the system are more flexible and the practicality of the system is further enhanced.

### BRIEF DESCRIPTION OF THE DRAWINGS

The present invention will become more fully understood from the detailed description given herein below for illustration only, and thus are not limitative of the present invention, and wherein:

FIG. 1 is a schematic diagram of first system architecture according to an embodiment of the present invention;

FIG. 2 is a schematic diagram of second system architecture according to an embodiment of the present invention;

FIG. 3 is a schematic diagram of playing Picture and Picture manner according to an embodiment of the present invention;

FIG. 4 is a schematic diagram of playing Picture in Picture according to an embodiment of the present invention;

FIG. 5 is a schematic diagram of third system architecture according to an embodiment of the present invention;

FIG. 6 is a schematic structural view of a server according to an embodiment of the present invention;

FIG. 7 is a schematic flow chart of a method for displaying product information about advertisement on digital television according to an embodiment of the present invention; and

FIG. 8 is a preceding schematic flow chart of a method for displaying product information about advertisement on digital television according to an embodiment of the present invention.

### DETAILED DESCRIPTION OF THE INVENTION

The present invention is described in the exemplary embodiments with reference to the accompany drawings in the following.

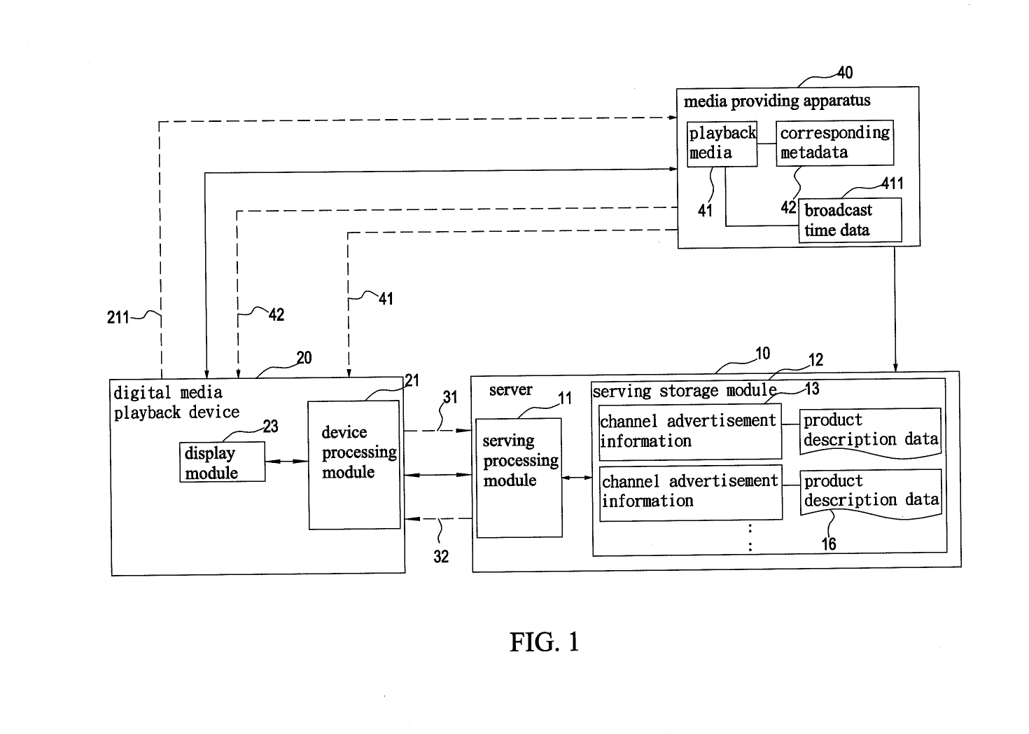

FIG. 1 is a schematic diagram of first system architecture according to an embodiment of the present invention. The system includes a digital media playback device 20 and a server 10 that are connected through a network. The digital media playback device 20 may be a digital television or a digital set top box that is connected to a television, or an electronic device which can play digital media and select channels. However, the present invention is not limited hereto.

The digital media playback device 20 mainly includes a device processing module 21 and a display module 23. A user may use a control interface of the digital media playback device 20 (for example, a remote control communicating with a digital television apparatus to control the digital television apparatus to switch channels by wireless, such as the infrared ray, the Bluetooth or the microwave) to input channel information 211. The device processing module 21 acquires one of a plurality of playback media 41 from a media providing apparatus 40 according to the channel information 211, and plays the playback media 41 on a display module 23. For example, when a user uses a control interface (such as a remote control) to input channel information 211 and the media providing apparatus 40 is a remote digital television server to receive a digital television signal and an original digital text signal (such as an Internet Protocol Television (IPTV) system, Connected television, or Chunghwa Telecom MOD), the device processing module 21 transmits the channel information 211 to the media providing apparatus 40 to acquire playback media 41 for playback. In another embodiment, when the media providing apparatus 40 is a digital media broadcast apparatus of a digital radio television station, the digital media playback device 20 receives playback media provided by digital television channels of a plurality of digital radio television stations (such as Taiwan Television (TTV), China Television (CTV), Chinese Television System (CTS), Formosa Television (FTV), and Public Television Service (PTS) in Taiwan) through a wired or wireless network, so the current media playback channel for the digital media playback device 20 may be changed to the inputted media playback channel according to the channel information 211 to play the playback media 41.

The server 10 includes a serving storage module 12 and a serving processing module 11. The serving storage module 12 stores at least one piece of channel advertisement information 13. The device processing module 21 may transmit an instruction of advertisement information 31 including specific information 221 to the server 10. The channel advertisement information 13 is provided to a serving processing module 11 to find target product description data 32 according to the specific information 221. For example, the target product description data 32 corresponding to each piece of specific information 221 may be directly recorded, or correspondence data between the specific information 221 and corresponding product description data 16 may be recorded in the channel advertisement information 13. In some embodiments, when the specific information 221 is channel information 211 (television channel), the channel advertisement information 13 may include a playback channel and a broadcast time of each piece of playback media, and corresponding product description data 16. The serving processing module 11, upon receiving the channel information 211 (that is, the specific information 221), may find corresponding target product description data 32 according to the channel information 211 and a time of receiving the channel information 211 (which represents a current broadcast time of current playback media).

Furthermore, the media providing apparatus 40 of a media provider may provide broadcast time data 411 of the playback media 41 played in the channel to the server 10. For example, a playback schedule of the playback media in a specific channel is provided to record playback media played in each time segment in the specific channel, or a broadcast time table of each piece of playback media is provided to record in which channels and at which time segments each piece of the playback media is to be played. The serving processing module 11 may establish, according to the data provided by a plurality of media providing apparatuses 40, the channel advertisement information 13 to be stored in the serving storage module 12.

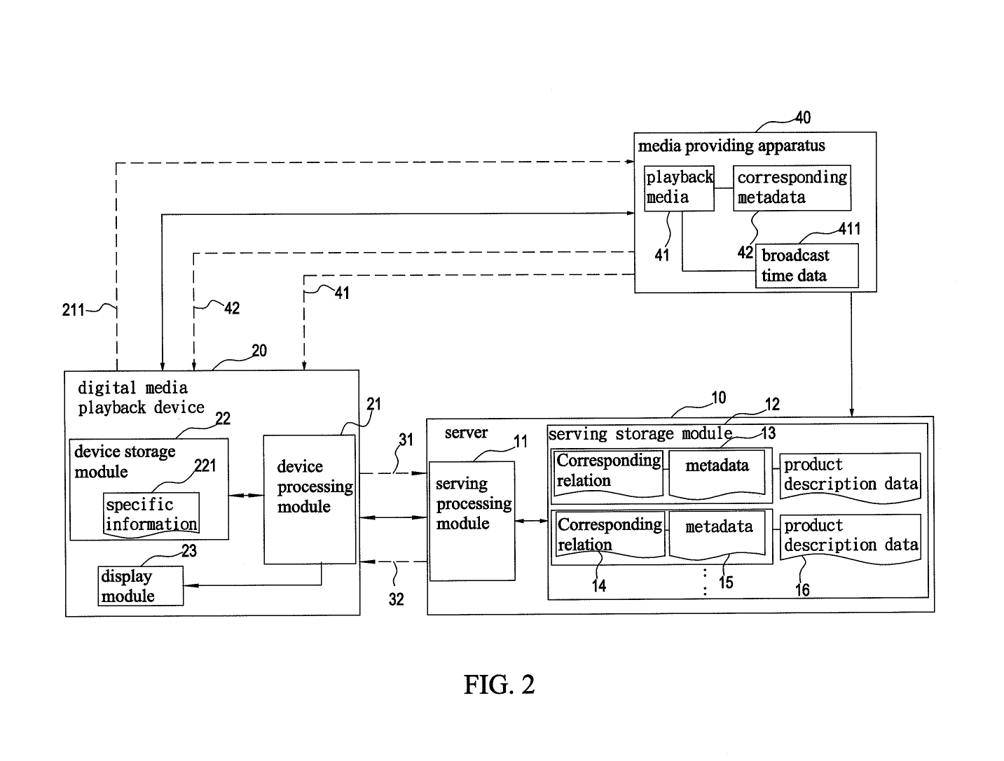

FIG. 2 is a schematic diagram of second system architecture according to an embodiment of the present invention. The embodiment further includes a device storage module 22 for storing specific information 221 to be accessed and used by the device processing module 21.

In view of FIG. 1 and FIG. 2, the playback media 41 may directly include corresponding specific information 221 and the device processing module 21 may directly acquire the specific information 221 while acquiring the playback media 41. Alternatively, the specific information 221 may be stored in the device storage module 22. The device processing module 21 may access the device storage module 22 and acquire the specific information 221 when necessary, and send out an instruction of advertisement information 31 including the specific information 221. The specific information stored in the device storage module 22 may be stored after being retrieved from the playback media 41 during the process that the digital media playback device 20 receives the playback media 41, or may be otherwise provided by the media providing apparatus 40 and stored.

Then, the serving processing module 11 compares the specific information 221 comprised in the instruction of advertisement information 31 with all channel advertisement information 13 to find a piece of target product description data 32 from the product description data 16 and then return the target product description data 32 to the digital media playback device 20.

When the digital media playback device 20 acquires the target product description data, the device processing module 21 may play the playback media 41 and the target product description data on the display module 23 at the same time.

However, the broadcast time data 411 of the playback media 41 played in each channel may be input by a human machine interface or an operational interface of the server 10, or may be acquired from an external storage device connected to the server 10 for data establishment and update.

The channel advertisement information records a correspondence relation between the specific information and the at least one piece of product description data. The two forms of implementation of the specific information 221 are listed as follows.

(1) A device processing module 21 stores acquired channel information 211 in a device storage module 22 to be used as specific information 221. When acquiring an instruction of advertisement information 31 and comparing channel information 211 with a channel advertisement information 13, a server 10 compares an acquisition time of the channel information 211 and the instruction of advertisement information 31 with a correspondence relation 14 recorded in the channel advertisement information 13, so as to find out the target product description data that most matches with the channel information 211.

(2) The channel advertisement information 13 records a correspondence relation 14 between a plurality of metadata 15 and the product description data 16. The metadata 15 may include a product name, a product model, a manufacturer and a product feature. The specific information 221 is corresponding metadata 42 that corresponds to playback media 41 and is acquired when the digital media playback device 20 acquires the playback media 41. While comparing the specific information 221 of the instruction of advertisement information 31 with the channel advertisement information 13, the serving processing module 11 compares the corresponding metadata 42 with the correspondence relation 14 recorded in the channel advertisement information 13.

The media providing apparatus 40 integrates the corresponding metadata 42 corresponding to the playback media 41 and transfers to the digital media playback device 20. The device processing module 21 further integrates the corresponding metadata 42 into the instruction of advertisement information 31.

The serving processing module 11 acquires the corresponding metadata 42 from the instruction of advertisement information 31. During the data comparison operation, the serving processing module 11 compares the corresponding metadata 42 and the product description data 16 to assist to find out the target product description data 32. However, the product description data 16 may comprise data or characters, which are the same as, matche with, depend on each other, or have correspondence relation with the corresponding metadata 42, or the metadata 15.

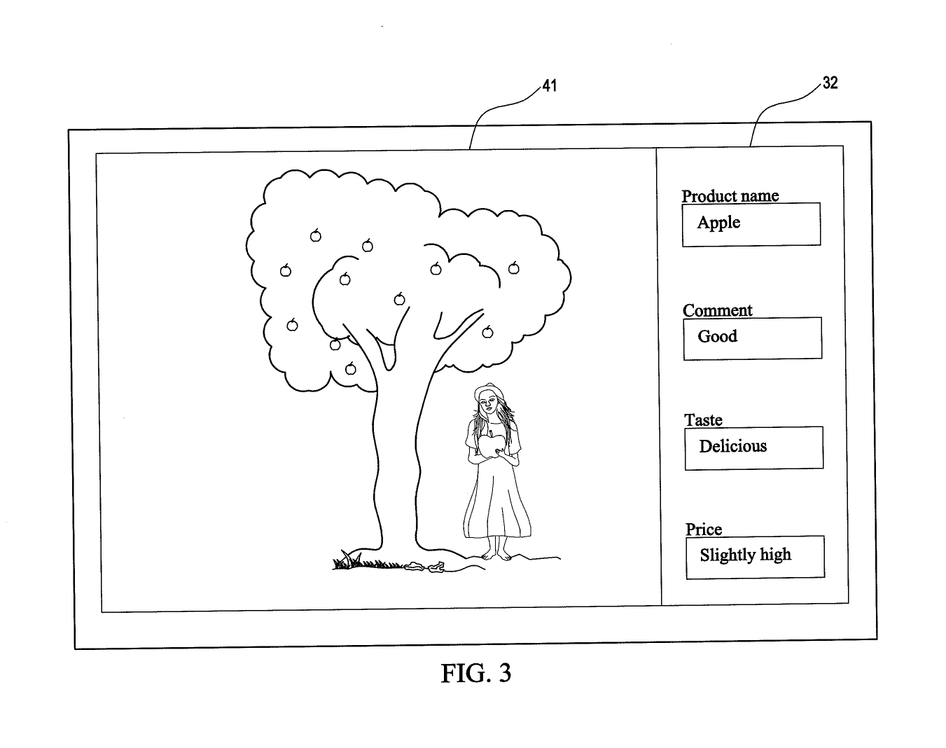

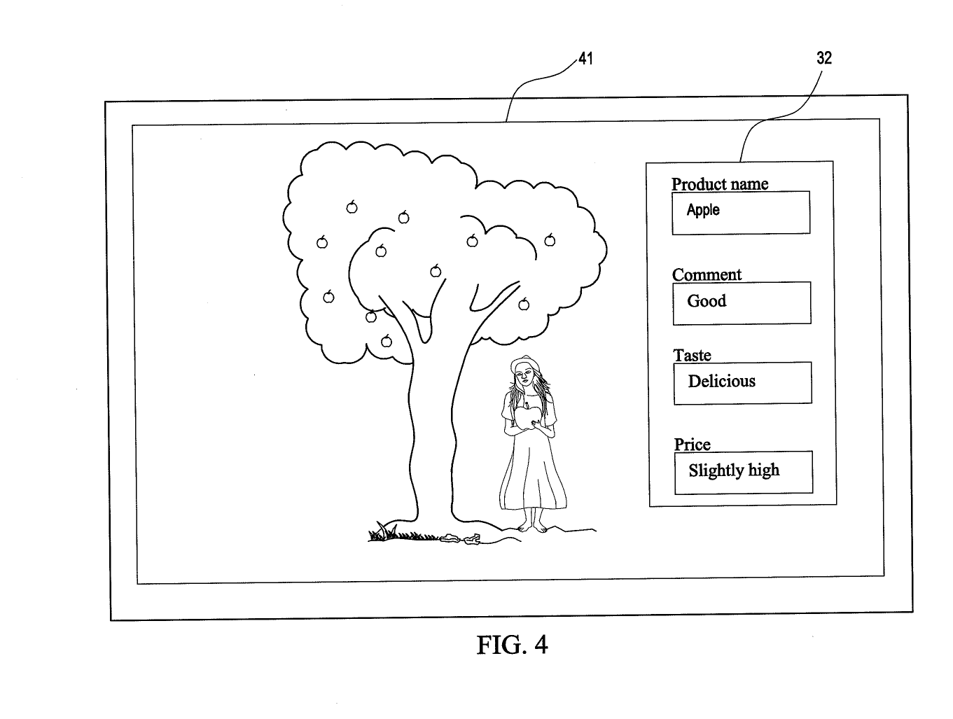

FIG. 3 is a schematic diagram of playing Picture and Picture manner according to an embodiment of the present invention. FIG. 4 is a schematic diagram of playing Picture in Picture according to an embodiment of the present invention. The device processing module 21 plays the playback media 41 and the target product description data 32 on the display module 23. The device processing module 21 plays the playback media 41 and the target product description data 32 on the display module 23 in a Picture and Picture manner or a Picture in Picture manner.

Moreover, each piece of product description data 16 may include a path information for a purchase platform of a product, which includes a uniform resource locator (URL) of a website of an online shopping platform of the manufacturer. While presenting the product description data 16, the display module 23 of the digital media playback device 20 may present the path information of the purchase platform of the product at the same time. A user may select the path information of the purchase platform of the product through a control interface of the digital media playback device 20. The digital media playback device 20 may be connected to the shopping platform of the manufacturer by the path information and the user can order the product from the manufacturer through the shopping platform.

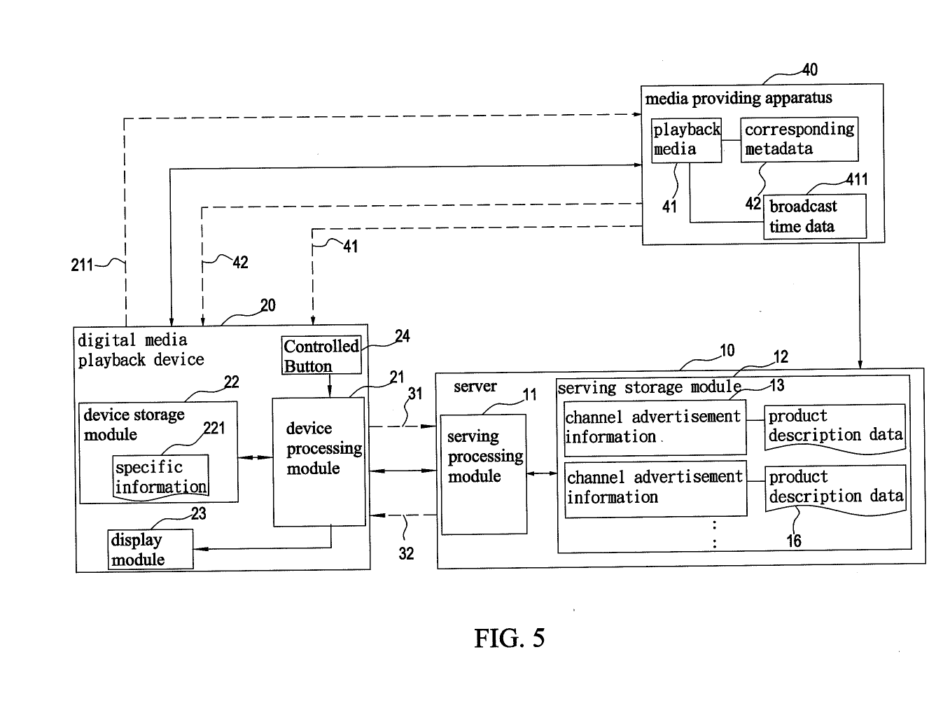

FIG. 5 is a schematic diagram of third system architecture according to an embodiment of the present invention. The difference between this embodiment and the above embodiments lies in that the digital media playback device 20 further includes a controlled button 24. The controlled button 24 may be a software key (such as a button build by software) or hardware key (such as a button build by hardware) according to the type of the digital media playback device 20. After the device processing module 21 judges that the controlled button 24 is pressed, the device processing module 21 begins to generate the above-mentioned instruction of advertisement information 31. Accordingly, the user may determine the acquisition time of the product description data 16. Alternatively, the system may further include a remote control (not shown). When the digital media playback device 20 acquires a control signal sent from the remote control, the device processing module 21 begins to generate the above-mentioned instruction of advertisement information 31.

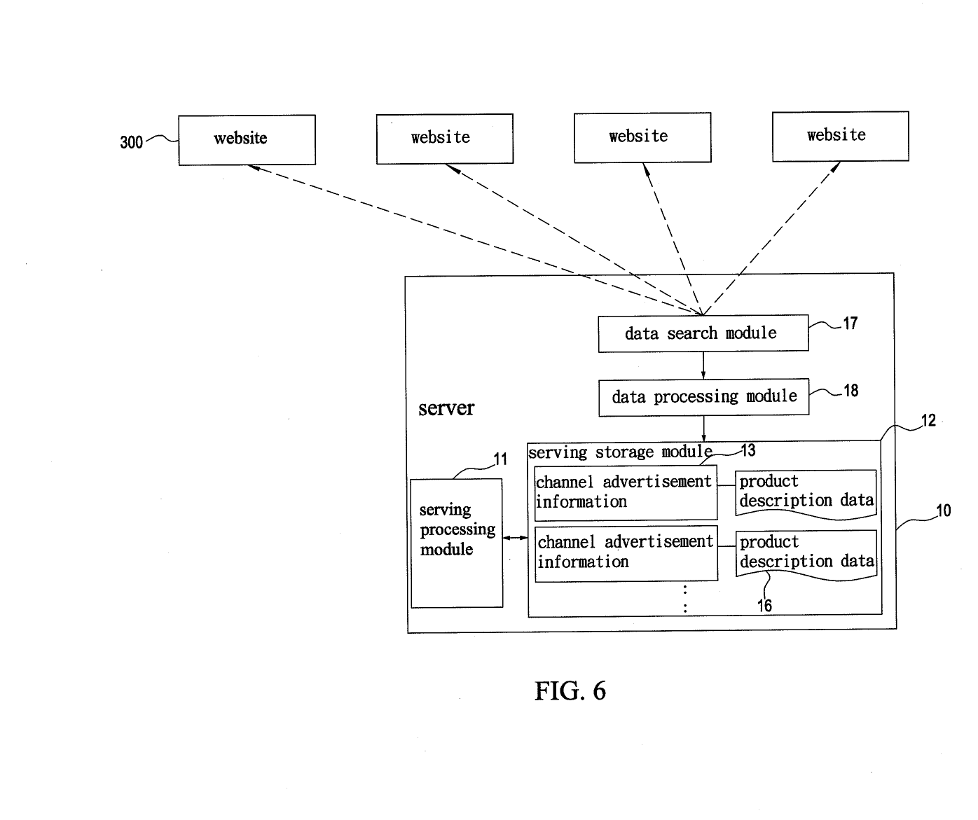

FIG. 6 is a schematic structural view of a server 10 according to an embodiment of the present invention. The server 10 includes a data search module 17 and a data processing module 18. The data search module 17 stores at least one search strategy of the product corresponding to the advertisement media of each product. The strategy is used for searching at least one piece of search data that meets the search strategy on the Internet. The search strategy may include at least one keyword. The keyword may be, for example, a product name or any other keywords that can be used for performing product related search, and be used to search the at least one piece of search data. Therefore, the search data include the above keyword. Alternatively, the search strategy may include a URL of at least one website 300, and the search data are data stored in the website designated by the search strategy. However, the data search method is not limited hereto, and any method capable of data collection is applicable.

The data processing module 18 is used for analyzing the search data searched by the data search module 17, forms, according to a product corresponding to the search data, comment data of the product in the advertisement media of each product, and stores the comment data as the product description data 16 of the related product. A data analysis method may be a fuzzy analysis method, and a neural data analysis method, or any other method capable of data analysis is applicable, which is not limited in the present invention.

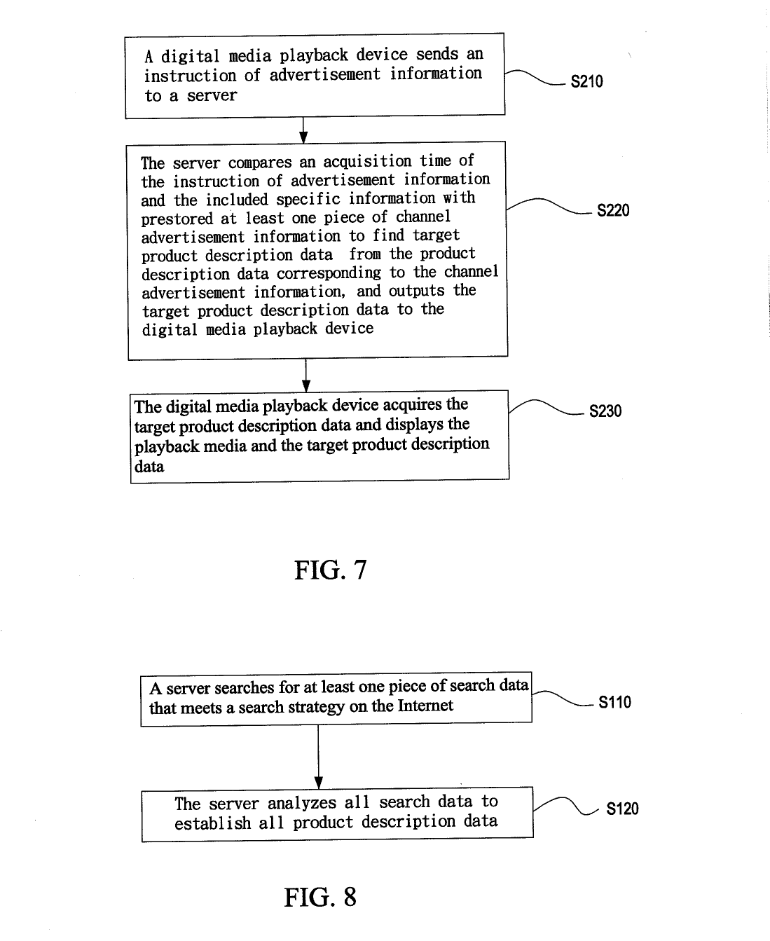

FIG. 7 is a schematic flow chart of a method for displaying product information about advertisement on digital television according to an embodiment of the present invention, which is applicable to a server 10 and a digital media playback device 20 that are connected through a network. Refer to FIG. 1 to FIG. 5 at the same time for ease of understanding. The process of the method includes the following steps.

A digital media playback device 20 sends an instruction of advertisement information 31 to a server 10 (S210). Referring to FIG. 2, specific information 221 is stored in a device storage module 22. The specific information 221 may be the channel information 211 described in the above embodiments. Referring to FIG. 1, the specific information 221 may be corresponding metadata 42. Also, the device processing module 21 may transmit an instruction of advertisement information 31 including the specific information 221 to the server 10.

Also, referring to FIG. 5, the digital media playback device 20 further includes a controlled button 24. After the device processing module 21 judges that the controlled button 24 is pressed, the device processing module 21 begins to generate the above-mentioned instruction of advertisement information 31, which is regarded as a time for implementing Step 5210.

The server 10 compares an acquisition time of the instruction of advertisement information 31 and the included specific information 221 with prestored at least one piece of channel advertisement information 13 to find target product description data 32 from the product description data 16 corresponding to the channel advertisement information 13, and outputs the target product description data 32 to the digital media playback device 20 (S220).

Same as the above, the specific information 221 may be the channel information 211 or the correspondence metadata 42 described in the above embodiments. If the specific information 221 is the channel information 211, while comparing the specific information 221 of the instruction of advertisement information 31 with the channel advertisement information 13, the serving processing module 11 compares an acquisition time of the channel information 211 and the instruction of advertisement information 31 with the correspondence relation 14 recorded in the channel advertisement information 13. Alternatively, if the specific information is the corresponding metadata 42, while comparing the specific information 221 of the instruction of advertisement information 31 with the channel advertisement information 13, the serving processing module 11 compares the corresponding metadata 42 with the correspondence relation 14 recorded in the channel advertisement information 13.

The digital media playback device 20 acquires the target product description data 32 and displays the playback media 41 and the target product description data 32 (S230). The device processing module 21 plays the target product description data 32 on the display module 23. The presented data is, for example, the appearance, price, applicability, comments of a product or other related product feature description, which is not limited in the present invention.

However, before the method is implemented, a media providing apparatus 40 of a media provider provides broadcast time data 411 of playback media that is played on a channel to the server 10 so that the serving processing module 11 may establish the channel advertisement information 13 to be stored in the serving storage module 12.

FIG. 8 is a preceding schematic flow chart of a method for displaying product information about advertisement on digital television according to an embodiment of the present invention, which is applicable to a server 10 and a digital media playback device 20 that are connected through a network. Refer to FIG. 1 to FIG. 5 at the same time for ease of understanding.

A server 10 searches for at least one piece of search data that meets a search strategy on the Internet (S110). Referring to FIG. 5, a data search module 17 is used for searching at least one piece of search data that meets the search strategy on the Internet. The search strategy includes at least one keyword, so found content of the search data also include the above-mentioned keyword. Alternatively, the search strategy includes a URL of at least one website 300, and the found content of the search data is the data stored in the website designated by the search strategy.

The server 10 analyzes all search data to establish all product description data 16 (S120). Same as above, the data processing module 18 uses any type of data analysis method such as a fuzzy analysis method and a neural data analysis method to analyze the collected search data, and forms the product description data 16 of a product in the advertisement media of each product.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for displaying product information about advertisement on digital television, comprising:
a digital media playback device, comprising a device processing module and a display module, wherein the device processing module acquires one of a plurality of playback media from a media providing apparatus through channel information for playback on the display module, and sends an instruction of advertisement information comprising specific information; and
a server, connected to the digital media playback device and comprising a serving storage module and a serving processing module, wherein the serving storage module stores at least one piece of channel advertisement information and at least one piece of product description data respectively corresponding to at least one of the plurality of playback media, while acquiring the instruction of advertisement information, the serving processing module compares the specific information with the at least one piece of channel advertisement information to find target product description data from the at least one piece of product description data and output to the digital media playback device; and
wherein the device processing module further plays the playback media and the target product description data on the display module while acquiring the target product description data.

2. The system for displaying product information about advertisement on digital television according to claim 1, wherein the channel advertisement information records corresponding relations of the plurality of playback media, a plurality of channels, a broadcast time, and the at least one piece of product description data, the specific information is the channel information; the serving processing module compares an acquisition time of the channel information and the instruction of advertisement information with the corresponding relations recorded in the channel advertisement information while comparing the specific information of the instruction of advertisement information with prestored at least one piece of channel advertisement information.

3. The system for displaying product information about advertisement on digital television according to claim 2, wherein the media providing apparatus provides broadcast time data for playback media to be played in a channel; the serving processing module establishes the channel advertisement information according to the plurality of playback media, broadcast time and at least one piece of product description data respectively corresponding to the plurality of playback media; and stores the channel advertisement information in the serving storage module.

4. The system for displaying product information about advertisement on digital television according to claim 1, wherein the channel advertisement information records corresponding relations of a plurality of metadata and the at least one piece of product description data, the specific information is corresponding metadata corresponding to the playback media acquired while the digital media playback device acquires the playback media; and the server compares the specific information of the instruction of advertisement information with prestored at least one piece of channel advertisement information, that is, compares the corresponding metadata with the corresponding relations recorded in the channel advertisement information.

5. The system for displaying product information about advertisement on digital television according to claim 4, wherein the media providing apparatus integrates the corresponding metadata corresponding to the playback media and transfers to the digital media playback device; and the device processing module integrates the corresponding metadata into the instruction of advertisement information.

6. The system for displaying product information about advertisement on digital television according to claim 1, further comprising a device storage module, used for storing the specific information, wherein the device processing module accesses the device storage module to acquire the specific information and sends the instruction of advertisement information of the specific information.

7. The system for displaying product information about advertisement on digital television according to claim 1, wherein the server further comprises a data search module and a data processing module, the data search module stores at least one search strategy of a product corresponding to each piece of the playback media to search for at least one piece of search data that meets the search strategy on the Internet; and the data processing module analyzes each piece of the search data to establish each piece of the product description data.

8. The system for displaying product information about advertisement on digital television according to claim 7, wherein the search strategy comprises at least one keyword; and content of the at least one piece of search data comprises the at least one keyword.

9. The system for displaying product information about advertisement on digital television according to claim 7, wherein the search strategy comprises a uniform resource locator (URL) for at least one website; and content of the at least one piece of search data comprises data of the at least one website.

10. The system for displaying product information about advertisement on digital television according to claim 7, wherein the data processing module—to analyze each piece of the search data to form comment data of a product in each piece of the playback media by fuzzy and stores each piece of the comment data as each piece of the product description data.

11. The system for displaying product information about advertisement on digital television according to claim 1, wherein the digital media playback device further comprises a controlled button, and the device processing module sends the instruction of advertisement information when judging that the controlled button is pressed.

12. The system for displaying product information about advertisement on digital television according to claim 1, wherein while acquiring the playback media and the target product description data, the device processing module presents the playback media and the target product description data in a Picture and Picture manner or a Picture in Picture manner.

13. A method for displaying product information about advertisement on digital television, applicable to a server and a digital media playback device that are connected through a network, wherein the digital media playback device acquires playback media from a media providing apparatus through channel information for playback; and the server stores at least one piece of product description data respectively corresponding to at least one of the plurality of playback media; and the method comprises:
sending, by the digital media playback device, an instruction of advertisement information to the server, wherein the instruction of advertisement information comprises specific information;
comparing, by the server, the specific information of the instruction of advertisement information with the at least one piece of channel advertisement information to find target product description data from the at least one piece of product description data corresponding to the channel advertisement information and output to the digital media playback device; and
acquiring, by the digital media playback device, the target product description data to display the playback media and the target product description data.

14. The method for displaying product information about advertisement on digital television according to claim 13, wherein the channel advertisement information records corresponding relations of the plurality of playback media, a plurality of channels, a broadcast time, and the at least one piece of product description data, the specific information is the channel information; and the server compares the specific information of the instruction of advertisement information with prestored at least one piece of channel advertisement information, that is, compares an acquisition time of the channel information and the instruction of advertisement information with the corresponding relations recorded in the channel advertisement information.

15. The method for displaying product information about advertisement on digital television according to claim 14, further comprising:
providing, by the media providing apparatus, broadcast time data for playback media to be played in a channel; and then the server establishes the channel advertisement information according to the plurality of playback media, broadcast time and at least one piece of product description data respectively corresponding to the plurality of playback media; and stores the channel advertisement information in a serving storage module.

16. The method for displaying product information about advertisement on digital television according to claim 13, wherein the channel advertisement information records corresponding relations of a plurality of metadata and the at least one piece of product description data, the specific information is corresponding metadata corresponding to the playback media acquired while the digital media playback device acquires the playback media; and the server compares the specific information of the instruction of advertisement information with prestored at least one piece of channel advertisement information, that is, compares the corresponding metadata with the corresponding relations recorded in the channel advertisement information.

17. The method for displaying product information about advertisement on digital television according to claim 16, wherein the media providing apparatus integrates the corresponding metadata corresponding to the playback media and transfers to the digital media playback device; and the digital media playback device further integrates the corresponding metadata into the instruction of advertisement information.

18. The method for displaying product information about advertisement on digital television according to claim 13, further comprising:
searching for, by the server, at least one piece of search data that meets at least one search strategy on the Internet, wherein the at least one search strategy corresponding to a product in each piece of the playback media is prestored in the server; and
analyzing, by the server, each piece of the search data to establish each piece of the product description data.

19. The method for displaying product information about advertisement on digital television according to claim 18, wherein in the step of analyzing, by the server, each piece of the search data to establish each piece of the product description data, the server analyzes each piece of the search data to form comment data on a product in each piece of the playback media by fuzzy and stores each piece of the comment data as each piece of the product description data.

20. A non-transitory recording medium, storing a computer readable program code, wherein a server and a digital media playback device that are connected through a network read the program code to collaborate to implement a method for displaying product information about advertisement on digital television, the digital media playback device acquires playback media from a media providing apparatus through channel information for playback; the server stores at least one piece of product description data respectively corresponding to at least one of the plurality of playback media; and the method comprises:
sending, by the digital media playback device, an instruction of advertisement information to the server, wherein the instruction of advertisement information comprises specific information;
comparing, by the server, the specific information of the instruction of advertisement information with the at least one piece of channel advertisement information to find target product description data from the at least one piece of product description data corresponding to the channel advertisement information and output to the digital media playback device; and
acquiring, by the digital media playback device, the target product description data and displays the playback media and the target product description data.
